(19) United States
(12) Patent Application Publication
(10) Pub. No.: US 2024/0284510 A1
(43) Pub. Date: Aug. 22, 2024

(54) RANDOM ACCESS PROCEDURE IN SUBBAND FULL-DUPLEXING

(71) Applicant: MediaTek Singapore Pte. Ltd., Singapore (SG)

(72) Inventors: Sumaila Anning Mahama, Cambridge (GB); Mohammed S Aleabe Al-Imari, Cambridge (GB); Jozsef Gabor Nemeth, Cambridge (GB)

(21) Appl. No.: 18/423,412

(22) Filed: Jan. 26, 2024

Related U.S. Application Data
(60) Provisional application No. 63/483,021, filed on Feb. 3, 2023.

(51) Int. Cl. H04W 74/0833; H04L 5/00; H04W 72/1268; H04W 74/08

(52) U.S. Cl. CPC H04W 74/0833; H04L 5/0012; H04W 72/1268; H04W 74/0866

(57) ABSTRACT

In an aspect of the disclosure, a method, a computer-readable medium, and an apparatus are provided. The apparatus may be a UE. The UE receives a configuration of physical random access channel (PRACH) occasions from a base station. The configuration indicates one or more PRACH occasions located in each time unit of a set of time units. The UE determines whether a first PRACH occasion in a first time unit of the set of time units is valid in the time domain by assessing whether the first time unit is partitioned or non-partitioned. The UE transmits a random access preamble at the first PRACH occasion when the first PRACH occasion is valid in the time domain and is also valid in the frequency domain.

### CROSS-REFERENCE TO RELATED APPLICATION(S)

This application claims the benefits of U.S. Provisional Application Ser. No. 63/483,021, entitled “RANDOM ACCESS PROCEDURE IN SBFD” and filed on Feb. 3, 2023, which is expressly incorporated by reference herein in its entirety.

### BACKGROUND

### Field

The present disclosure relates generally to communication systems, and more particularly, to techniques of enhanced random access procedure in subband full-duplexing.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives a configuration of physical random access channel (PRACH) occasions from a base station. The configuration indicates one or more PRACH occasions located in each time unit of a set of time units. The UE determines whether a first PRACH occasion in a first time unit of the set of time units is valid in the time domain by assessing whether the first time unit is partitioned or non-partitioned. The UE transmits a random access preamble at the first PRACH occasion when the first PRACH occasion is valid in the time domain and is also valid in the frequency domain.

In another aspect of the disclosure, a method, a computer-readable medium, and an apparatus are provided. The apparatus may be a UE. The UE receives a first configuration to derive a first frequency domain position for use in a non-partitioned uplink-only time unit. The UE receives, from a base station, a Random Access Response (RAR) that includes a scheduling grant for transmitting a first Physical Uplink Shared Channel (PUSCH) in a first time unit of a set of time units. The UE determines if the first time unit is a non-partitioned uplink-only time unit. The UE transmits the first PUSCH in the first time unit using the first frequency domain position when it is determined that the first time unit is a non-partitioned uplink-only time unit.

In yet another aspect of the disclosure, a method, a computer-readable medium, and an apparatus are provided. The apparatus may be a UE. The UE receives a Physical Uplink Control Channel (PUCCH) configuration for frequency hopping from a base station in response to a message 4 during a random access procedure. The UE determines a resource block number in a first slot for each frequency hop of the PUCCH transmission, where the resource block number for a first hop and a second hop is determined using different equations depending on the value of a PUCCH index. The UE transmits a Hybrid Automatic Repeat Request Acknowledgement (HARQ-ACK) on the PUCCH in the first slot in response to the message 4 when frequency hopping is not disabled, applying frequency hopping according to the determined resource block number.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a random access procedure.

FIG. 8 is a diagram illustrating a frequency hopping for PUSCH and PUSCH repetitions scheduled by random access response (RAR).

FIG. 9 is a flow chart of a method (process) for transmitting a random access preamble.

FIG. 10 is a flow chart of a method (process) for transmitting a PUSCH.

FIG. 11 is a flow chart of a method (process) for physical uplink control channel (PUCCH) transmission with frequency hopping in response to a message 4 in a random access procedure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

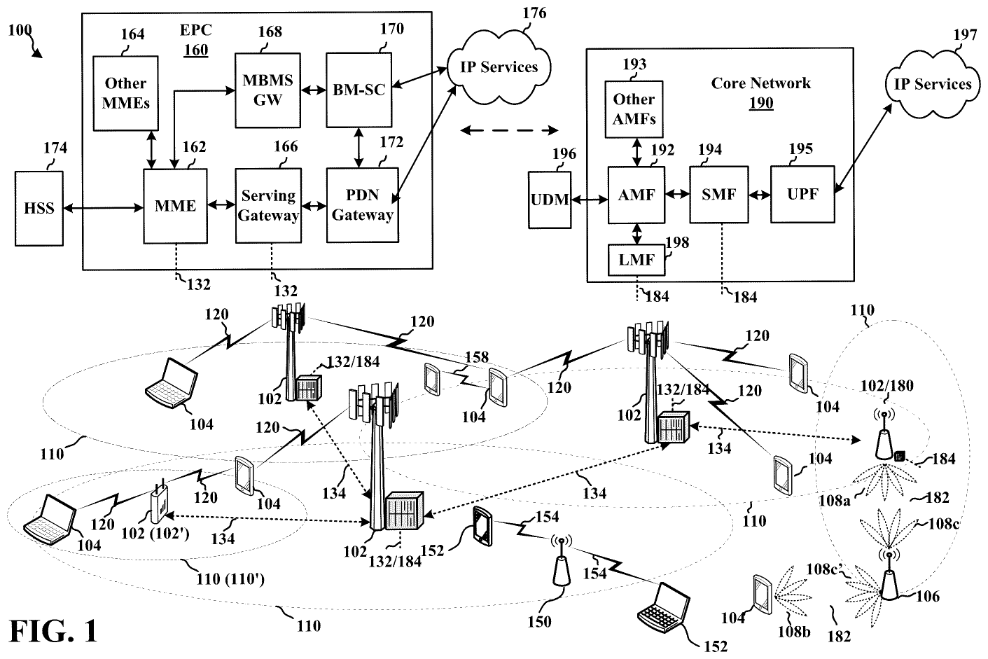

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage arca 110. There may be overlapping geographic coverage areas 110. For example, the small cell 102′ may have a coverage area 110′ that overlaps the coverage arca 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) arca broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (cNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

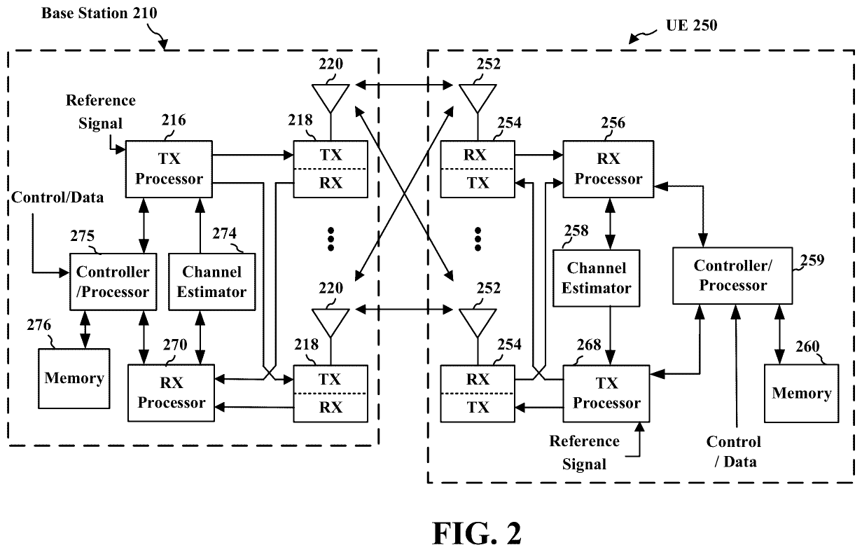

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (cMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

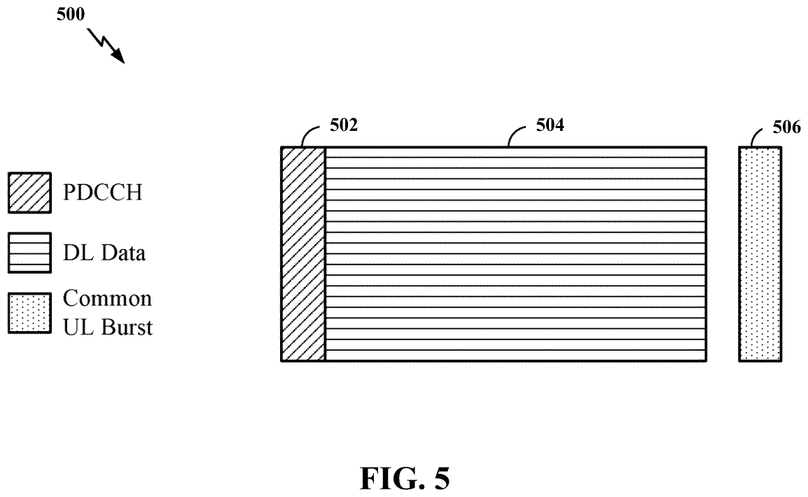

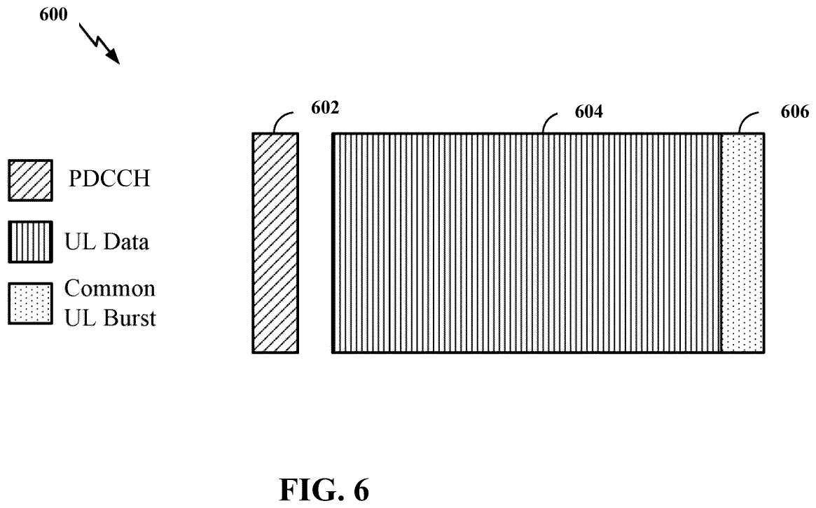

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

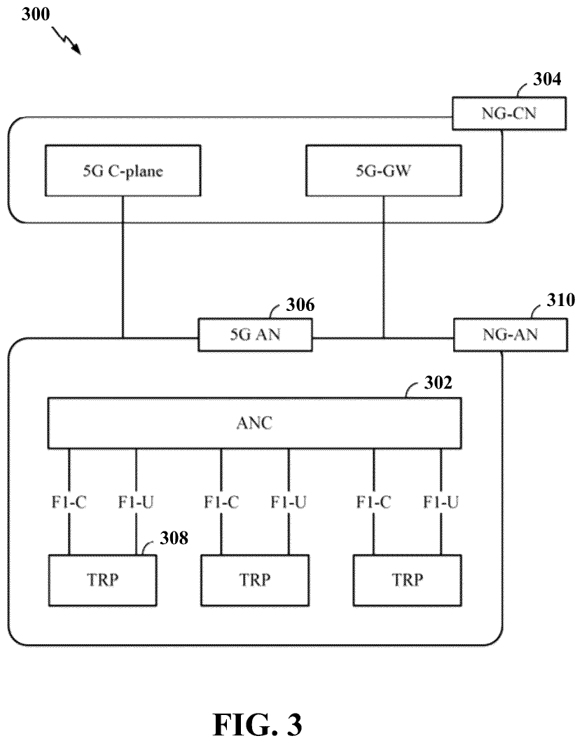

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

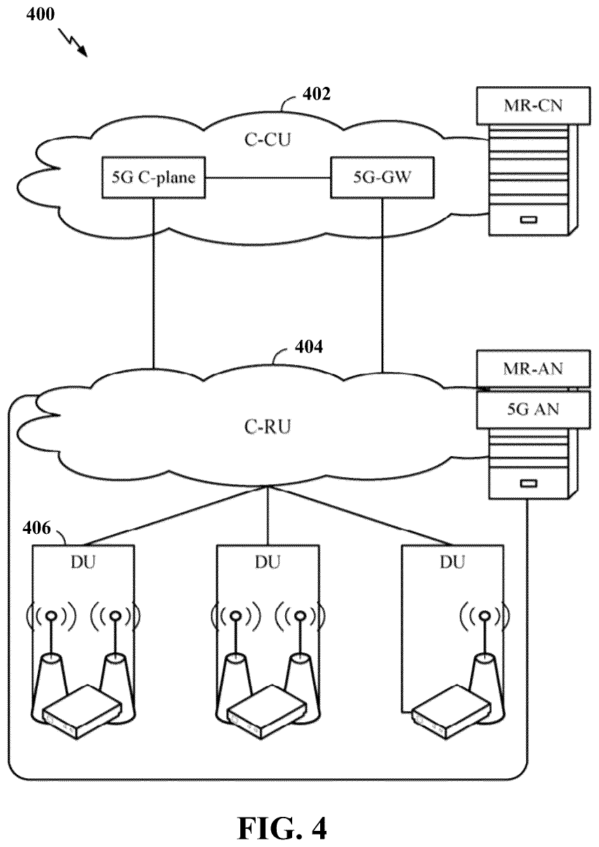

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

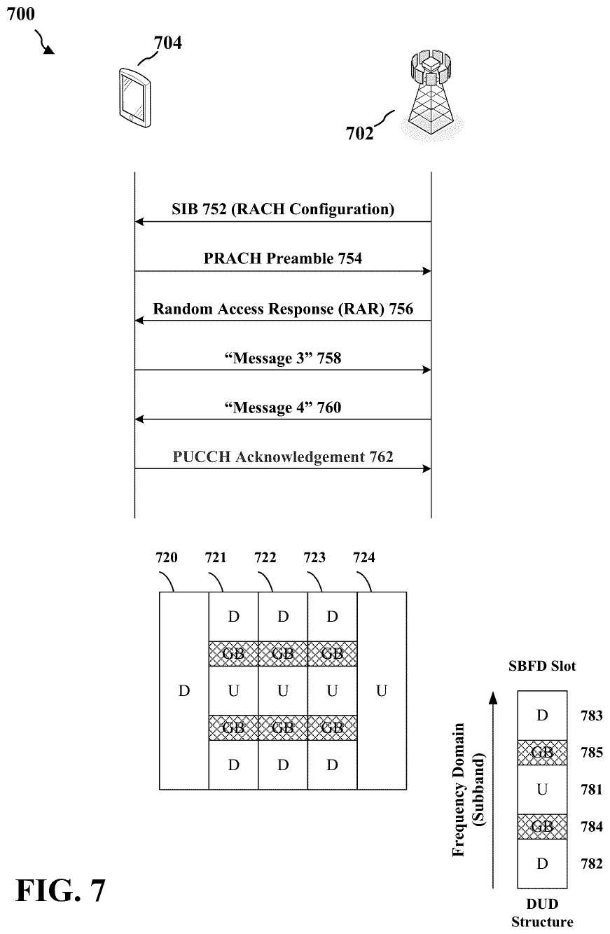

FIG. 7 illustrates the random access procedure in a diagram 700, where a UE 704 initiates a connection to a base station 702. The base station 702 broadcasts System Information Blocks (SIBs) 752 on the Broadcast Control Channel (BCCH). The UE 704 monitors the BCCH to receive the SIB 752, which contains random access configuration information including PRACH occasions, preamble formats, timing advance, and mappings from SSB indices to PRACH occasions.

Upon determining the PRACH occasions, the UE 704 transmits one or more preambles 720 within these occasions. The base station 702, upon detecting a preamble 754, issues a Random Access Response (RAR) 756. The RAR 756 includes the detected preamble index, a timing correction for the UE 704, a scheduling grant for subsequent message 3 transmission, and a temporary Cell Radio Network Temporary Identifier (C-RNTI) for further communication.

Following the reception of the RAR 756, the UE 704 becomes time-synchronized with the base station 702. The UE 704 then transmits message 3 (758) using the assigned UL-SCH resources from the RAR 756, which includes a unique device identity for contention resolution.

If the base station 702 successfully decodes message 3 (758), it responds with a contention resolution response (message 4) 760. This response includes a downlink scheduling command on the Physical Downlink Control Channel (PDCCH), addressed to the temporary C-RNTI or an existing C-RNTI, followed by a transmission on the Physical Downlink Shared Channel (PDSCH) containing a MAC control element echoing the unique identity received.

The UE 704, upon recognizing its identity in the contention resolution response 760, concludes that the procedure is successful. It sends an uplink acknowledgment 762 on the Physical Uplink Control Channel (PUCCH) and adopts the temporary C-RNTI as a permanent C-RNTI if it did not have one previously. If the UE 704 does not hear its identity, it backs off and restarts the procedure.

In this example, a base station 702 operates according to Time Division Duplexing (TDD) with a subband full-duplexing (SBFD) feature. The base station 702 dynamically allocates frequency resources in the time domain. For example, the TDD configuration may follow a pattern such as DXXXU, where ‘D’ represents a downlink-only slot, ‘U’ represents an uplink-only slot, and ‘X’ represents a slot that can be configured for either downlink or uplink transmissions, or both, in the case of SBFD slots.

In this example, a downlink-only slot 720 is exclusively reserved for downlink (DL) transmissions, where the BS 702 transmits radio frequency (RF) signals. Conversely, the uplink-only slot 724 is exclusively reserved for uplink (UL) transmissions, where the BS 702 receives RF signals from a UE 704 and other UEs.

SBFD slots 721, 722, and 723 are partitioned into separate subbands for DL and UL transmissions, allowing the BS 702 to simultaneously transmit and receive RF signals within the same slot. In this example, these SBFD slots are characterized by non-overlapping DL subbands 782 and 783, a central UL subband 781, and guardbands (GB) 784 and 785 providing isolation between the DL and UL subbands.

In this example, the SBFD subband configuration within the SBFD slots follows a DUD pattern, indicating the presence of DL subbands on either side of a central UL subband. As such, DL transmissions from the base station 702 occur in the DL-only slot 720 and within the DL subbands 782 and 783 of the SBFD slots. UL transmissions to the base station 702 take place in the UL-only slot 724 and within the UL subband 781 of the SBFD slots. The DL-only slot 720 and the UL-only slot 724 are referred to as non-partitioned slots, while the SBFD slots 721, 722, and 723 are considered partitioned slots due to their mixed UL and DL resource allocation.

Further, the UE 704 is SBFD-aware. SBFD slots offers the UE 704 additional UL resources, which can be leveraged for Physical Random Access Channel (PRACH) transmissions.

The base station 702 broadcasts System Information Blocks (SIBs) containing configuration information, including Physical Random Access Channel (PRACH) occasions. The UE 704 monitors these broadcasts to obtain the necessary information to synchronize and communicate with the base station 702.

In a first aspect, the base station 702 can configure PRACH occasions based on the type of slot or symbols. A slot or symbol may be partitioned or non-partitioned as described supra. A slot is considered “non-partitioned” if its allocated resources for transmission (such as PRACH occasions) only overlap with symbols that are designated for uplink or downlink transmission. This means that the entire slot is dedicated to either uplink or downlink, consistent with traditional TDD configurations, without any mixing of uplink and downlink resources within the slot. Conversely, a slot is considered “partitioned” if its allocated resources overlap with symbols that are not exclusively defined as uplink or downlink. In the context of SBFD, partitioned slots are those that have been divided into subbands to accommodate both uplink and downlink transmissions simultaneously.

The UE 704 can be configured to use PRACH occasions on specific sets of slots/symbols, allowing for targeted and efficient use of the available spectrum.

In a first setting, the configured PRACH occasions can include both partitioned slots, such as SBFD slots 721, 722, and 723, and non-partitioned slots, such as the uplink-only slot 724.

In a second setting, the UE 704 is configured by the base station 702 to only use PRACH occasions located in the SBFD slots 721, 722, and 723. Specifically, the UE 704 transmits PRACH preambles only within the central UL subband 781 of the partitioned SBFD slots. The UE does not use the PRACH occasions available in the non-partitioned UL-only slot 724.

In a third setting, the UE 704 is configured by the base station 702 to only use PRACH occasions located in the non-partitioned UL-only slot 724. The UE 704 does not use the PRACH occasions available iin the SBFD slots 721, 722, and 723.

Furthermore, the validation rules for PRACH occasions can be relaxed for SBFD-aware UEs 704. That is, a PRACH occasion can be considered valid if it occurs within symbols defined as flexible and/or downlink by the tdd-UL-DL-ConfigurationCommon. This relaxation enables the utilization of additional uplink resources available in partitioned slots for PRACH transmission, thereby enhancing the random access procedure's efficiency.

A PRACH occasion is traditionally only considered valid by the UE 704 if the PRACH occasion coincides with symbols that are defined as uplink by the tdd-UL-DL-ConfigurationCommon. However, with the introduction of subband full-duplex (SBFD), additional uplink resources can become available during symbols marked as “flexible” or even “downlink” in the tdd-UL-DL-ConfigurationCommon.

Specifically, in the system with base station 702 and UE 704, the SBFD slots 721, 722, and 723 contain a central uplink subband 781 in addition to the outer downlink subbands 782 and 783. Even though the carrier direction of these SBFD slots may be defined as downlink in the tdd-UL-DL-ConfigurationCommon, PRACH transmissions could still occur within the uplink subband 781.

Therefore, to allow the UE 704 to take advantage of these extra uplink resources in the SBFD slots, the validation rules for PRACH occasions can be relaxed. By considering a PRACH occasion as valid even if it falls on flexible or downlink symbols, the UE can now transmit PRACH preambles within the central uplink subband 781 of the partitioned SBFD slots. This provides more options for the UE to find available PRACH occasions.

The base station 702 can indicate PRACH occasions that occur on partitioned and non-partitioned slots/symbols to the UE 704 through a parameter in SIB1. Additionally, a bitmap can be employed to represent these occasions.

In this example, the base station 702 broadcasts a bitmap within the SIB1 to indicate the configuration of PRACH occasions to the UE 704. The bitmap is a binary representation where each bit corresponds to a specific slot, indicating whether it is configured for PRACH transmission. For simplicity, let's assume a bitmap of five bits corresponding to five slots, with the bit value ‘1’ indicating a slot configured for PRACH and ‘0’ indicating a slot not configured for PRACH.

Given the slots 720 (DL-only), 721, 722, 723 (SBFD slots with partitioned subbands), and 724 (UL-only), the bitmap can be represented as follows:

### Bitmap: 01111

In this bitmap representation, the first bit corresponds to slot 720, which is a DL-only slot and is not configured for PRACH, hence it is represented by ‘0’. The second bit corresponds to slot 721, which is an SBFD slot with partitioned subbands 781 (UL subband) and 782 (DL subband). This slot is configured for PRACH in the UL subband 781, so it is represented by ‘1’. The third bit corresponds to slot 722, which is similar to slot 721 with partitioned subbands and is also configured for PRACH in its UL subband, hence represented by ‘1’. The fourth bit corresponds to slot 723, which follows the same configuration as slots 721 and 722, and is also represented by ‘1’. The fifth bit corresponds to slot 724, which is an UL-only slot and is configured for PRACH, thus represented by ‘1’.

The UE 704, upon receiving this bitmap, can decode it to determine that slots 721, 722, 723, and 724 are valid for PRACH occasions. The UE 704 can then select an appropriate PRACH occasion based on its own timing and the base station's configuration. For instance, if the UE 704 decides to access the network, it can choose to transmit its PRACH preamble during the PRACH occasion in slot 724, which is an UL-only slot.

In scenarios where signaling is not preferred, the UE 704 can implicitly determine the validity of PRACH occasions based on its knowledge of the TDD pattern and the carrier's direction.

For instance, if the carrier's TDD configuration follows a pattern such as DXXXU, where ‘D’ represents a downlink-only slot and ‘U’ represents an uplink-only slot, the UE 704 can deduce that a PRACH occasion occurring on a slot not defined as uplink by the tdd-UL-DL-ConfigurationCommon is indicative of a partitioned slot. Consequently, the UE 704 can consider such occasions as valid for PRACH transmission.

In a second aspect, a single frequency domain allocation (FDRA) for PRACH occasions spanning across both slot types may lead to inefficiencies and potential overlap issues with downlink subbands (DL-SB), particularly in partitioned slots.

In a first technique of the second aspect, frequency domain invalidation rules for PRACH occasions based on slot type are defined.

In certain configurations, PRACH occasions can be deemed invalid if they overlap, either partially or fully, with DL-SB of a partitioned slot/symbol. For instance, if a PRACH occasion configured in a UL-only slot extends into the DL-SB of a subsequent partitioned slot, such as slot 721, 722, or 723, it would be considered invalid.

The base station 702 can communicate the slot partition pattern to the UE 704 via a parameter in System Information Block 1 (SIB1). In one example, a bitmap is utilized to represent the partitioning pattern. For example, a bitmap indicating ‘0’ for non-partitioned slots and ‘1’ for partitioned slots could be employed. This bitmap allows the UE 704 to discern which slots are configured for PRACH occasions and which are not, enabling it to make informed decisions on when to initiate PRACH transmissions.

In scenarios where explicit signaling is not utilized, a fixed slot partition pattern can be established for all partitioned slots/symbols. For example, the base station 702 has a fixed slot partition pattern for all partitioned slots/symbols that is known to both the base station 702 and the UE 704. This pattern could be a standard configuration that is commonly used across the network and is pre-configured in the UE 704 during its manufacturing or through a software update before deployment.

For example, the fixed slot partition pattern may dictate that slots 721, 722, and 723 are partitioned slots with a specific configuration of downlink and uplink subbands. In this pattern, the downlink subbands 782 and 783 are located at the beginning and end of the frequency spectrum of each slot, while the uplink subband 781 is situated in the center. This configuration might be represented as DUD, where ‘D’ stands for downlink and ‘U’ for uplink subbands within the partitioned slots.

Since this partition pattern is fixed and known, there is no need for the base station 702 to signal this information to the UE 704. Instead, the UE 704, already equipped with this knowledge, can autonomously determine the position of downlink and uplink subbands without additional signaling from the base station. When the UE 704 initiates a PRACH procedure, it can independently ascertain that for partitioned slots 721, 722, and 723, the valid PRACH occasions can only occur within the uplink subband 781. Conversely, for non-partitioned slots, such as the UL-only slot 724, the UE 704 can use the entire slot for PRACH occasions.

In certain configurations, a PRACH occasion is considered valid by the UE 704 only if it occurs on slots/symbols that are explicitly defined as uplink by the tdd-UL-DL-ConfigurationCommon. This means that for a PRACH occasion to be deemed valid for transmission, it must align with the uplink resources within the TDD frame structure. For example, if the UL-only slot 724 is designated as an uplink slot in the tdd-UL-DL-ConfigurationCommon, then the UE 704 can utilize this slot for PRACH transmission without concerns of overlap with downlink transmissions.

In certain configurations, a PRACH occasion is regarded as valid only if it occurs on slots/symbols marked as flexible by the tdd-UL-DL-ConfigurationCommon. Flexible slots/symbols, such as those within the SBFD slots 721, 722, and 723, offer the potential for either uplink or downlink usage, depending on the dynamic scheduling decisions made by the base station 702. If a flexible slot is configured for uplink transmission during a given PRACH occasion, the UE 704 can transmit its PRACH preamble within the central uplink subband 781 of the SBFD slots.

In certain configurations, the validation of a PRACH occasion extends to slots/symbols that are either defined as uplink or flexible by the tdd-UL-DL-ConfigurationCommon. This approach provides the UE 704 with greater flexibility and a higher probability of finding a valid PRACH occasion. It allows the UE 704 to transmit PRACH preambles in both the UL-only slot 724 and the flexible subbands of the SBFD slots 721, 722, and 723, as long as those subbands are configured for uplink transmission during the PRACH occasion. For instance, if the base station 702 configures the central uplink subband 781 for uplink transmission, the UE 704 can initiate PRACH in any of the SBFD slots, taking advantage of the additional uplink resources provided by the SBFD configuration.

In a second technique of the second aspect, two frequency domain positions are defined for PRACH occasions based on slot type. For instance, the first frequency domain position is designed for use in non-partitioned slots, such as the UL-only slot 724.

Conversely, the second frequency domain position is specifically intended for partitioned slots, such as slots 721, 722, and 723, which contain both UL subband 781 and DL subbands 782 and 783.

By implementing two frequency domain positions for PRACH occasions based on slot type, the base station 702 can optimize the allocation of PRACH resources in an SBFD system.

In certain configurations, the UE 704 receives indications of which frequency domain position to apply to specific sets of slots/symbols. In one example, the two frequency domain positions are provided through a parameter in SIB1 to the UE 704.

For example, the base station 702 uses the parameters msg1-FDM and msg1-FrequencyStart within the RACH-ConfigGeneric to define the first frequency domain position for PRACH occasions. This configuration is suitable for non-partitioned slots, such as the UL-only slot 724, where the entire slot is reserved for uplink transmissions. The msg1-FDM parameter specifies the number of frequency resources that are multiplexed, and the msg1-FrequencyStart parameter indicates the starting frequency resource block (RB) for the PRACH occasion within the uplink bandwidth.

To further enhance the flexibility and efficiency of PRACH resource allocation in SBFD systems, an additional set of parameters, msg1-FDM2 and msg1-FrequencyStart2, can be introduced within RACH-ConfigGeneric. These new parameters are used to define a second frequency domain position that is specifically tailored for partitioned slots, such as slots 721, 722, and 723, which have subbands 781 for uplink and subbands 782 and 783 for downlink transmissions.

For instance, in a partitioned slot like slot 721, the base station 702 could configure the second frequency domain position using msg1-FDM2 and msg1-FrequencyStart2 to ensure that PRACH occasions are aligned with the uplink subband 781. This prevents overlap with the downlink subbands 782 and 783 and allows the UE 704 to transmit PRACH preambles without interfering with downlink transmissions occurring simultaneously within the same slot.

In certain configurations, the base station 702 communicates to the UE 704 the sets of slots where each frequency domain position is to be applied. This information may be conveyed through a parameter in System Information Block 1 (SIB1), which is broadcasted and accessible by all UEs within the cell, including UE 704. The parameter in SIB1 enables the UE 704 to determine the correct frequency domain position for PRACH occasions in different slot types.

The parameter in SIB1 indicates to UE 704 which frequency domain position to use for each slot. For example, the parameter may signal that the first frequency domain position, defined by existing parameters like msg1-FDM and msg1-FrequencyStart, is to be applied to the UL-only slot 724. Simultaneously, the second frequency domain position, defined by new parameters such as msg1-FDM2 and msg1-FrequencyStart2, is to be applied to the central uplink subband 781 of the partitioned SBFD slots 721, 722, and 723. Therefore, the UE 704 can align its PRACH transmissions with the appropriate frequency domain resources.

In certain configurations, to effectively communicate to the UE 704 which frequency domain position should be applied to a given slot, the base station 702 may utilize a bitmap. Each bit in the bitmap corresponds to a specific slot, with the value of the bit determining whether the first or second frequency domain position should be used for PRACH occasions within that slot.

For example, consider a bitmap of five bits corresponding to five slots, where the bit value ‘1’ indicates that the second frequency domain position (defined by msg1-FDM2 and msg1-FrequencyStart2) is to be applied, and the bit value ‘0’ indicates that the first frequency domain position (defined by msg1-FDM and msg1-FrequencyStart) is to be applied:

### Bitmap: 1110

In this bitmap representation: the first bit corresponds to slot 721, an SBFD slot with partitioned subbands 781 (UL subband) and 782 (DL subband). This slot uses the second frequency domain position for PRACH, so it is represented by ‘1’. The second bit corresponds to slot 722, which is similar to slot 721 with partitioned subbands and uses the second frequency domain position for PRACH, hence represented by ‘1’. The third bit corresponds to slot 723, which follows the same configuration as slots 721 and 722, and uses the second frequency domain position for PRACH, so it is represented by ‘1’. The fourth bit corresponds to the UL-only slot 724, which uses the first frequency domain position for PRACH, thus represented by ‘0’.

The UE 704, upon decoding this bitmap, can determine that slots 721, 722, and 723 are configured for the second frequency domain position for PRACH occasions, while slot 724 should use the first frequency domain position. The UE 704 can then select the appropriate PRACH occasion based on this configuration information provided by the base station 702.

Further, the base station 702 can utilize another bitmap to indicate to the UE 704 which sets of slots are configured for PRACH occasions. The bitmap indicates to the UE 704 the frequency domain positions applicable to the various slots, including the partitioned slots 721, 722, and 723 as well as the non-partitioned slots like the UL-only slot 724.

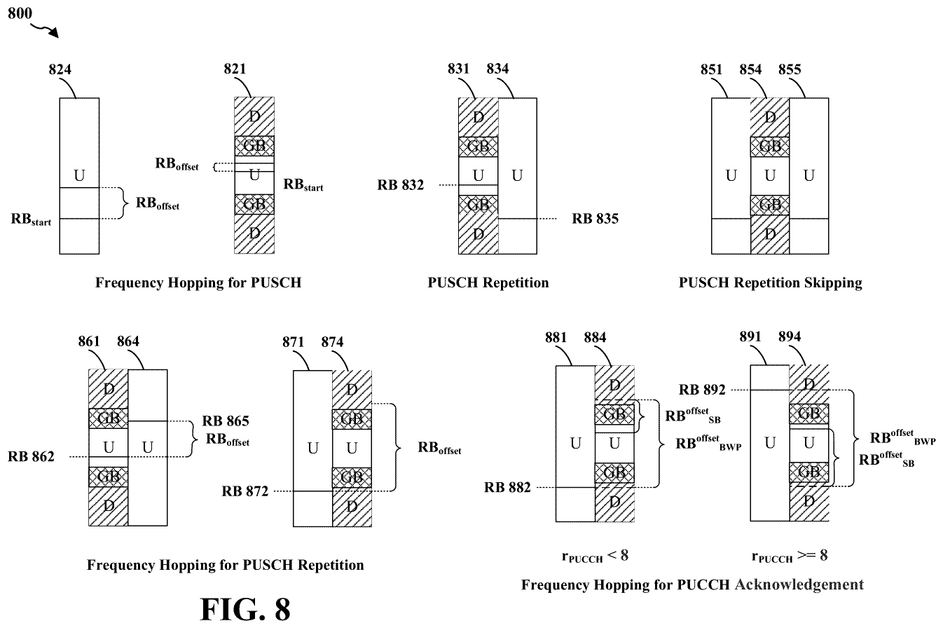

FIG. 8 is a diagram 800 illustrating a frequency hopping for PUSCH and PUSCH repetitions scheduled by random access response (RAR). In this example, the base station 702 enabled frequency hopping for a partitioned slot 821 and a non-partitioned UL-only slot 824. The partitioned slot 821, similar to the partitioned slots 721, 722, 723, include the DL subbands 782 and 783, the central UL subband 781, and the guardbands 784 and 785.

In a third aspect, frequency hopping can be configured for PUSCH scheduled by RAR. In SBFD, the FDRA for frequency hopping may overlap with the DL-SBs in partitioned slots. Slots can be partitioned into distinct downlink (DL) and uplink (UL) subbands. If the frequency hopping causes the UE 704 to hop into a frequency that overlaps with a DL subband within a partitioned slot, this would result in interference with downlink transmissions. This is particularly problematic if the hopping pattern extends to the edges of the frequency band where the DL resources are located,

In a first technique of the third aspect, when frequency hopping is enabled for PUSCH scheduled by an RAR UL grant, the base station 702 defines two frequency hopping offsets based on the slot type. A wide frequency hopping offset is applied for non-partitioned UL-only slots, such as slot 824, which is reserved exclusively for UL transmissions.

A narrow frequency hopping offset is defined for partitioned slots, such as SBFD slot 821, to ensure that the frequency after hopping does not overlap with the DL subband or guard subband within the same slot.

The UE 704 transmits, in the UL-only slot 824, a PUSCH (e.g., Msg3) scheduled by a RAR UL grant from the base station 702. The UE 704 may be instructed to hop from one frequency position to another between transmissions. This hopping could potentially cause the UE's transmission to intrude into the frequency space allocated for downlink transmissions, such as the DL subbands 782 and 783, when the subsequent slot is the partitioned slot 821.

The two frequency hopping offsets are applied by UEs that have the capability to transmit PUSCH on both partitioned slots (e.g. slot 821) as well as non-partitioned slots (e.g. slot 824). Further, the UE 704, which has the capability to transmit the PRACH on both partitioned and non-partitioned slots/symbols, is also considered capable of transmitting PUSCH on both types of slots/symbols. For example, UE 704 can be configured to transmit PUSCH in the UL subband 781 of a partitioned slot 821 and then hop to a different frequency in a subsequent non-partitioned UL-only slot 824.

For UEs that can only transmit PUSCH on non-partitioned slots, the legacy frequency hopping procedure is followed. These UEs use a single frequency hopping offset that is compatible with the non-partitioned slot structure.

In certain configurations, the two sets of frequency hopping offsets may be communicated to the UE 704 via parameters within the RAR UL grant. The first set of frequency hopping offset values is derived from the standard values provided in Table 8.3-1 of TS 38.213, which are appropriate for non-partitioned slots like the UL-only slot 824. This slot type permits a broader frequency hopping range since it is solely dedicated to UL transmissions.

For partitioned slots such as the slot 821, an additional set of frequency offset values is proposed. These values are more restrictive in range to prevent the hopped frequency from encroaching upon the DL subbands 782 and 783, which could lead to interference with DL transmissions occurring within the same slot.

Upon receiving these parameters, the UE 704 determines the suitable frequency hopping offset to apply based on the slot type it is transmitting in. If the UE 704 is capable of transmitting in both partitioned and non-partitioned slots, it will use both sets of frequency hopping offsets as needed. If the UE 704 is restricted to transmitting only in non-partitioned slots, it will adhere to the standard frequency hopping offset values and follow the legacy procedure.

The base station 702 can signal to the UE 704 which frequency hopping offset to apply to specific slots. This signaling can be explicit, such as through parameters in the RAR UL grant, or implicit, where the UE 704 deduces the slot type based on its understanding of the TDD configuration and SBFD pattern.

In certain configurations, a bitmap can be utilized to indicate the sets of slots where each set of frequency hopping offset is applied. Each bit in the bitmap corresponds to a specific slot, with the value of the bit determining whether the wide or narrow frequency hopping offset should be used for that slot. For example, a bitmap of ‘0101’ could indicate that the first and third slots (e.g., non-partitioned slots) should use the wide offset, while the second and fourth slots (e.g., partitioned slots) should use the narrow offset. The UE 704 decodes this bitmap and applies the appropriate offset accordingly. In certain configurations, another bitmap can be used to indicate the sets of slots.

In a second technique of the third aspect, frequency hopping can be configured to occur only on non-partitioned slots or symbols, such as the UL-only slot 824, which is dedicated exclusively for uplink transmissions. This approach adheres to the legacy frequency hopping procedure, ensuring compatibility and predictability in the system's behavior.

To facilitate this selective application of frequency hopping, the base station 702 communicates to the UE 704 which slots are designated for frequency hopping and/or which slots are not designated for frequency hopping through parameters included within the RAR UL grant. This grant provides explicit instructions to the UE 704, enabling it to determine the appropriate slots for applying frequency hopping. For instance, the base station 702 may indicate that frequency hopping should be applied to the UL-only slot 824, while it should be skipped for partitioned slots like slot 821 that contain both uplink and downlink subbands.

Moreover, a bitmap can be employed as a signaling mechanism to convey the sets of slots where frequency hopping should be either applied or omitted. Each bit corresponding to a particular slot. The value of the bit, ‘0’ or ‘1’, indicates whether the slot is non-partitioned or partitioned, respectively. For example, a bitmap value of ‘0’ would suggest that the corresponding slot is a non-partitioned slot where frequency hopping is enabled, while a value of ‘1’ would indicate a partitioned slot where frequency hopping should be skipped.

In scenarios where signaling is to be minimized or avoided, the frequency hopping flag within the RAR UL grant can be set to a default value of “0” to indicate that frequency hopping should not be applied when PUSCH is scheduled by RAR to occur on a partitioned slot or symbol.

More specifically, the base station 702 can leverage an existing frequency hopping (FH) flag within the RAR UL grant. For example, the RAR UL grant has a 1-bit FH flag that indicates if frequency hopping is enabled (FH flag=1) or disabled (FH flag=0) for the PUSCH transmission from the UE 704 scheduled by that grant.

The base station 702 can disable frequency hopping in specific slots by setting this FH flag to 0 whenever the scheduled PUSCH transmission occurs in those slots. For instance, to disable FH in the partitioned SBFD slots such as the slot 821, the base station can set FH flag=0 for the RAR UL grants scheduling PUSCH transmissions in the slot 821.

The UE 704 simply checks the FH flag within the grant and will skip applying frequency hopping if it is 0, regardless of which slot type (partitioned or non-partitioned) the transmission occurs in. So there is no need to explicitly signal through a bitmap which slots should disable FH. By leveraging the existing FH flag in this way, signaling overhead can be reduced while still allowing the base station 702 to disable FH selectively based on the slot type.

Further, PUSCH repetition type A allows the UE to repeat its Msg3 transmission multiple times over consecutive slots using the same frequency domain resource allocation (FDRA). The problem arises because the repetition slots may include both partitioned SBFD slots (that have separate UL and DL subbands) as well as non-partitioned uplink slots. Using the same FDRA over these different slot types can cause the PUSCH repetition to overlap with the downlink subband (DL-SB) in the partitioned SBFD slots, leading to interference.

Additionally, if frequency hopping is enabled across the PUSCH repetitions, the hopping in the partitioned slots could also end up in the DL-SB region.

In a fourth aspect, the UE 704 may be scheduled to transmit a PUSCH (i.e., Msg3), following a RAR from the base station 702. The RAR includes a scheduling grant for the PUSCH transmission. To optimize the use of frequency resources and avoid potential interference in the SBFD system, two frequency domain positions are defined for PUSCH repetition scheduled by the RAR based on the slot type. For non-partitioned UL-only slots, such as slot 834, a frequency domain position 835 is defined. This position is suitable for the entire bandwidth of the UL-only slot, as there are no concerns of overlapping with DL transmissions. Conversely, for partitioned slots like SBFD slot 831, a different frequency domain position 832 is defined to ensure that the PUSCH transmission does not overlap with the DL subbands or guardbands within the slot.

For example, where the UE 704 is scheduled to repeat a PUSCH transmission across consecutive slots, some of which may be partitioned. If the initial resource allocation for the PUSCH falls within the UL region of a non-partitioned slot and the subsequent repetition falls within a partitioned slot, the UE 704 must adapt its frequency domain position to avoid transmitting in the DL region of the partitioned slot. This adaptation is necessary because the resource allocation for PUSCH repetition must always be confined within the UL resources to prevent interference with DL transmissions.

More specifically, the base station 702 may schedule a PUSCH (such as Msg3) for the UE 704 and instruct it to perform repetitions of this message. The frequency domain position 835, which is applicable to the UL-only slot 834, is used when the repetitions are scheduled in non-partitioned slots that are exclusively reserved for UL transmissions.

Conversely, when repetitions are scheduled in partitioned slots, such as the SBFD slot 831, a different frequency domain position 832 may be utilized. This position is calculated to fit within the UL subband of the partitioned slot, avoiding overlap with the DL subbands and guardbands. The application of this frequency domain position allows the UE 704 to repeat the PUSCH transmission within the confines of the UL resources, even in slots that are otherwise shared between UL and DL transmissions.

The UE 704, capable of transmitting PUSCH on both partitioned and non-partitioned slots, applies the appropriate frequency domain position based on the type of slot it is transmitting in. This capability may be inferred from the UE's ability to transmit PRACH on both types of slots. If the UE 704 is limited to transmitting PUSCH only on non-partitioned slots, it follows the legacy procedure for PUSCH repetition scheduled by the RAR, utilizing the frequency domain position suitable for non-partitioned slots.

The frequency domain positions for PUSCH repetition are communicated to the UE 704 through parameters within the RAR UL grant. The standard PUSCH frequency resource allocation field within the RAR grant is used to define the first frequency domain position for non-partitioned slots. An additional parameter, referred to as PUSCH frequency resource allocation 2, is introduced within the RAR grant field to define the second frequency domain position for partitioned slots.

The assignment of frequency domain positions to specific sets of slots is indicated to the UE 704 by a parameter within the RAR UL grant. A bitmap can be utilized to represent this assignment, with each bit corresponding to a slot and its value indicating the applicable frequency domain position.

In a second technique of the fourth aspect, during the PUSCH scheduling process, the BS 702 may instruct the UE 704 to perform PUSCH repetitions, which involve transmitting the same message across multiple slots. However, when repetitions are scheduled across a mix of partitioned SBFD slots and UL-only slots, challenges arise if the frequency domain resource allocation (FDRA) for the repetitions overlaps with DL subbands in the partitioned slots. To address this, the system supports the skipping of PUSCH repetitions for specific sets of slots where such overlaps occur.

For example, if a PUSCH repetition initially scheduled in an UL-only slot 851 is to be repeated in a subsequent partitioned SBFD slot 854, and the FDRA for this repetition overlaps with the DL subband of slot 854, the repetition for slot 854 is skipped. The decision to skip repetitions is communicated to the UE 704 via a parameter within the RAR UL grant, which can be represented using a bitmap. Each bit in the bitmap corresponds to a slot, indicating whether a repetition is to be skipped for that slot.

If the UE 704 encounters a slot indicated for skipping, such as the SBFD slot 854, it has two options: postponing or dropping the repetition. In the postponing scenario, the UE 704 defers the repetition that would have occurred in the skipped slot to the next available UL-only slot, such as slot 855. As such, the repetition occurs within UL resources, avoiding interference with DL transmissions. In the dropping scenario, the UE 704 entirely omits the repetition for the skipped slot and does not attempt to transmit in the next UL-only slot either.

In a third technique of the fourth aspect, when frequency hopping is enabled for PUSCH repetitions scheduled by RAR, frequency hopping on specific set of slots is supported. Frequency hopping for PUSCH repetitions scheduled by RAR is enabled on only non-partitioned slots/symbols. In this example, the UE 704 may perform frequency hopping at the UL-only slot 864 from the frequency domain position RB 862 of the SBFD slot 861 with an RB offset to the RB 865. The frequency hopping may follow the legacy frequency hopping procedure. The UE 704 may skip frequency hopping on a set of slots according to a parameter within the RAR UL grant 730. A bitmap can be used to indicate the sets of slots where frequency hopping is skipped. The set of slots where frequency hopping is applied or skipped can be indicated to the UE 704 without signaling. The frequency hopping from RB 872 on the UL-only slot 871 to the SBFD slot 874 with an RB offset is skipped because the resource allocation after the frequency hopping overlaps with a DL-subband in the SBFD slot 874.

In a fifth aspect, for PUCCH transmission in response to Message 4 prior to receiving dedicated UE configuration, the RB number for each frequency hop are defined as follows:

$$For {r}_{PUCCH} < 8 ,$$

$$RB No . ( j ) = \{ \begin{matrix}{RB}_{BWP}^{offset} + [ \frac{{r}_{PUCCH}}{{N}_{CS}} ] + {RB}_{SB}^{offset} ( j ) & first hop \\ {N}_{RB}^{size} ( j ) - {RB}_{BWP}^{offset} - ( 1 + ⌊ \frac{{r}_{PUCCH}}{{N}_{CS}} ⌋ ) - {RB}_{SB}^{offset} ( j ) & second hop\end{matrix}$$

$$For {r}_{PUCCH} \geq 8 ,$$

$$RB No . ( j ) = \{ \begin{matrix}{N}_{RB}^{offset} ( j ) - {RB}_{BWP}^{offset} - ( 1 + [ \frac{{r}_{PUCCH} - 8}{{N}_{CS}} ] ) - {RB}_{SB}^{offset} ( j ) & first hop \\ {RB}_{BWP}^{offset} + ⌊ \frac{{r}_{PUCCH} - 8}{{N}_{CS}} ⌋ + {RB}_{SB}^{offset} ( j ) & second hop\end{matrix}$$

where

$${r}_{P U C C H} = ⌊ \frac{2 \times {n}_{CCE , 0}}{{N}_{CCE}} ⌋ + 2 \times {Δ}_{PRI} , {RB}_{BWP}^{offset}$$

is the PRB offset, N_{RB}^{size}(j) is the maximum number of RBs for the set of slots with index j, RB_{SB}^{offset}(j) determines the additional PRB offset to account for the DL-subband in partitioned slots/symbols 884 or 894 (RB_{SB}^{offset}(j)=0 for non-partitioned slots/symbols 881 or 891), Δ_{PRI} is the value of the PUCCH resource indicator field in DCI, n_{CCE,0} is the index of the first CCE for the PDSCH reception, N_{CCE} is the number CCEs within the CORESET, N_{CS} is the number of initial CS indices.

The sets of slots where each RB number is applied can be indicated to the UE 704 by a parameter in SIB1. A bitmap can be used to indicate the sets of slots. The bit value serves as a pointer to a table that defines the values of N_{RB}^{size}(i) and RB_{SB}^{offset}(j). RB_{BWP}^{offset} is selected from a set of integer values between 1 and N_{RB}^{size}(j)−1. BWP

Disabling of frequency hopping for PUCCH transmission in response to message 4 based on slot type is supported. Frequency hopping can be disabled for specific set of slots (e.g., SBFD slot 884 or 894). The PUCCH resource is mapped to a PRB on one side of the UL bandwidth of the specific set of slots (e.g., UL-only slot 881 or 891). The PRB for the PUCCH resource is counted in increasing order from the lower edge of the UL bandwidth of the specific set of slots (e.g., UL-only slot 881 or 891). The PRB for the PUCCH resource is counted in decreasing order from the upper edge of the UL bandwidth of the specific set of slots (e.g., UL-only slot 881 or 891). The sets of slots where frequency hopping is disabled, is indicated to the UE 704 by a parameter in SIB1. A bitmap can be used to indicate the sets of slots where frequency hopping is disabled.

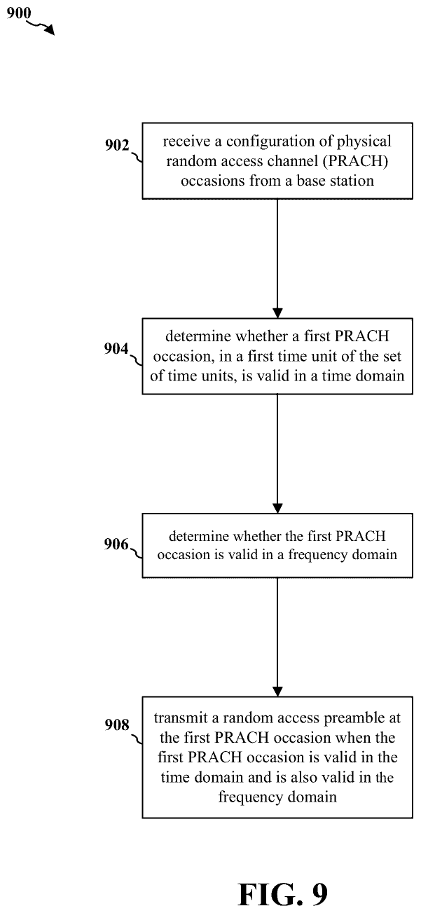

FIG. 9 is a flow chart 900 of a method (process) for transmitting a random access preamble. The method may be performed by a UE (e.g., the UE 704). In operation 902, the UE receives a configuration of physical random access channel (PRACH) occasions from a base station. The configuration indicates one or more PRACH occasions located in each time unit of a set of time units. In certain configurations, each time unit of the set of time units is a slot. In certain configurations, each time unit of the set of time units is a symbol.

In operation 904, the UE determines whether a first PRACH occasion, in a first time unit of the set of time units, is valid in a time domain based on whether the first time unit is partitioned or non-partitioned. In certain configurations, to determine whether the first PRACH occasion is valid in the time domain, the UE determines the first time unit is partitioned. In certain configurations, to determine whether the first PRACH occasion is valid in the time domain, the UE determines the first time unit is partitioned or non-partitioned.

In operation 906, the UE determines whether the first PRACH occasion is valid in a frequency domain. In certain configurations, the UE further receives an indication of a frequency domain resource allocation for the first PRACH occasion, determines whether the frequency domain resource allocation for the first PRACH occasion overlaps with a downlink frequency region in the first time unit, and determines the first PRACH occasion is invalid when the frequency domain resource allocation overlaps with the downlink frequency region in the first time unit.

In certain configurations, the UE further receives a first frequency domain resource allocation applicable for a PRACH occasion in a non-partitioned time unit, receives a second frequency domain resource allocation applicable for a PRACH occasion in a partitioned time unit, determines a selected frequency domain resource allocation, from the first frequency domain resource allocation and the second frequency domain resource allocation, for the first PRACH occasion based on whether the first time unit is partitioned or non-partitioned, and determines the first PRACH occasion is invalid when the selected frequency domain resource allocation overlaps with the downlink frequency region in the first time unit.

In operation 908, the UE transmits a random access preamble at the first PRACH occasion when the first PRACH occasion is valid in the time domain and is also valid in the frequency domain.

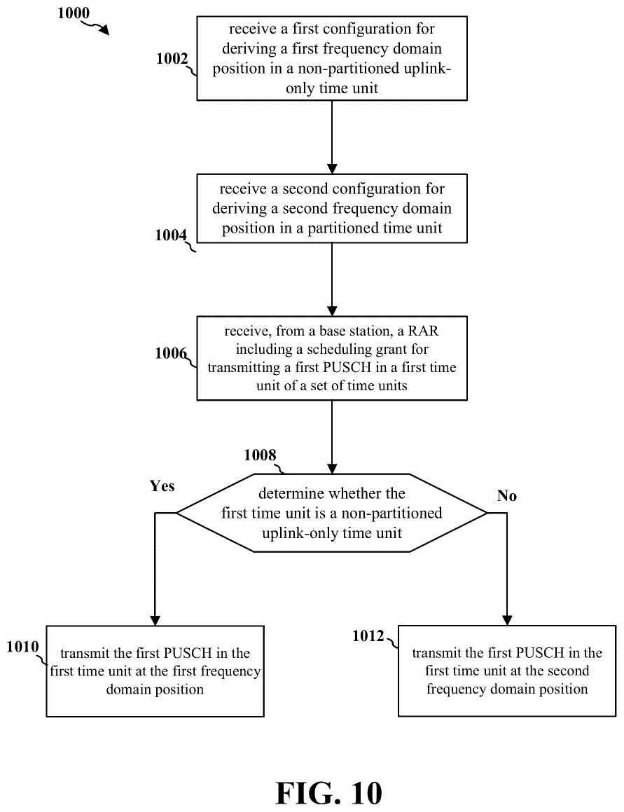

FIG. 10 is a flow chart 1000 of a method (process) for transmitting a PUSCH. The method may be performed by a UE (e.g., the UE 704). In operation 1002, the UE receives a first configuration for deriving a first frequency domain position in a non-partitioned uplink-only time unit. In certain configurations, the first configuration includes a first frequency hopping offset. The UE applies the first frequency hopping offset to derive the first frequency domain position.

In operation 1004, the UE receives a second configuration for deriving a second frequency domain position in a partitioned time unit. In certain configurations, the second configuration includes a second frequency hopping offset. The UE applies the second frequency hopping offset to derive the second frequency domain position when the first time unit is determined to be a partitioned time unit. The second frequency hopping offset is narrower than the first frequency hopping offset.

In operation 1006, the UE receives, from a base station (e.g., the base station 702), a Random Access Response (RAR) including a scheduling grant for transmitting a first Physical Uplink Shared Channel (PUSCH) in a first time unit of a set of time units.

In certain configurations, the UE receives an indication indicating enablement or disablement of frequency hopping within the RAR. When the indication indicates disablement of frequency hopping, the UE disables frequency hopping for transmitting the first PUSCH. In certain configurations, the UE receives a bitmap indicating the set of time units. In certain configurations, each bit of the bitmap corresponds to a respective time unit. In certain configurations, the bitmap indicates frequency hopping is disabled for partitioned time units and enabled for non-partitioned uplink-only time units.

In operation 1008, the UE determines whether the first time unit is a non-partitioned uplink-only time unit. When the first time unit is determined to be a non-partitioned uplink-only time unit, in operation 1010, the UE transmits the first PUSCH in the first time unit in accordance with the first frequency domain position. When the first time unit is determined to be a partitioned time unit, in operation 1012, the UE transmits the first PUSCH in the first time unit at the second frequency domain position.

In certain configurations, the scheduling grant schedules transmissions of a plurality of PUSCHs, including the first PUSCH, in the set of time units as repetitions. A corresponding one of the plurality of PUSCHs is transmitted in a given time unit at the first frequency domain position when the given time unit is a non-partitioned uplink-only time unit. A corresponding one of the plurality of PUSCHs is transmitted in a given time unit at the second frequency domain position when the given time unit is a partitioned time unit and the second frequency domain position does not overlap with a downlink subband. In certain configurations, the UE skips a transmission of a corresponding one of the plurality of PUSCHs when the given time unit is a partitioned time unit and the second frequency domain position overlaps with a downlink subband. In certain configurations, the UE receives a configuration indicating for each time unit in the set whether frequency hopping is enabled or disabled. The UE applies frequency hopping for a corresponding one of the plurality of PUSCHs based on the configuration when the given time unit is a non-partitioned uplink-only time unit.

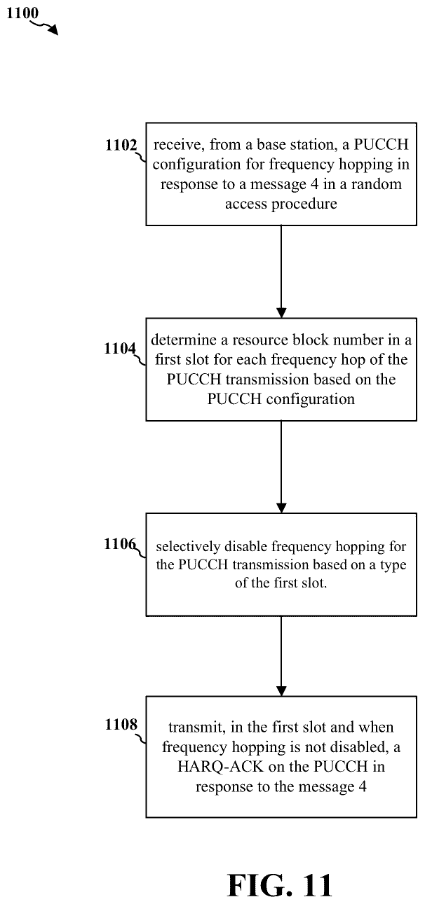

FIG. 11 is a flow chart 1100 of a method (process) for physical uplink control channel (PUCCH) transmission with frequency hopping in response to a message 4 in a random access procedure. The method may be performed by a UE (e.g., the UE 704). In operation 1102, the UE receives, from a base station, a PUCCH configuration for frequency hopping in response to a message 4 in a random access procedure. In operation 1104, the UE determines a resource block number in a first slot for each frequency hop of the PUCCH transmission based on the PUCCH configuration. The resource block number for a first hop and a second hop is determined using different equations contingent on a value of a PUCCH index.

In certain configurations, in operation 1106, the UE selectively disables frequency hopping for the PUCCH transmission based on a type of the first slot. The frequency hopping is disabled for partitioned slots with downlink subbands. In operation 1108, the UE transmits, in the first slot and when frequency hopping is not disabled, a Hybrid Automatic Repeat Request Acknowledgement (HARQ-ACK) on the PUCCH in response to the message 4. The HARQ-ACK transmission applies frequency hopping according to the determined resource block number.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a configuration of physical random access channel (PRACH) occasions from a base station, the configuration indicating one or more PRACH occasions located in each time unit of a set of time units;
determining whether a first PRACH occasion, in a first time unit of the set of time units, is valid in a time domain based on whether the first time unit is partitioned or non-partitioned; and
transmitting a random access preamble at the first PRACH occasion when the first PRACH occasion is valid in the time domain and is also valid in a frequency domain.

2. The method of claim 1, wherein each time unit of the set of time units is a slot.

3. The method of claim 1, wherein each time unit of the set of time units is a symbol.

4. The method of claim 1, wherein determining whether the first PRACH occasion is valid in the time domain comprises:
determining the first time unit is partitioned.

5. The method of claim 1, wherein determining whether the first PRACH occasion is valid in the time domain comprises:
determining the first time unit is partitioned or non-partitioned.

6. The method of claim 1, further comprising:
receiving an indication of a frequency domain resource allocation for the first PRACH occasion;
determining whether the frequency domain resource allocation for the first PRACH occasion overlaps with a downlink frequency region in the first time unit; and
determining the first PRACH occasion is invalid when the frequency domain resource allocation overlaps with the downlink frequency region in the first time unit.

7. The method of claim 1, further comprising:
receiving a first frequency domain resource allocation applicable for a PRACH occasion in a non-partitioned time unit;
receiving a second frequency domain resource allocation applicable for a PRACH occasion in a partitioned time unit;
determining a selected frequency domain resource allocation, from the first frequency domain resource allocation and the second frequency domain resource allocation, for the first PRACH occasion based on whether the first time unit is partitioned or non-partitioned; and
determining the first PRACH occasion is invalid when the selected frequency domain resource allocation overlaps with the downlink frequency region in the first time unit.

8. A method of wireless communication of a user equipment (UE), comprising:
receiving a first configuration for deriving a first frequency domain position in a non-partitioned uplink-only time unit;
receiving, from a base station, a Random Access Response (RAR) including a scheduling grant for transmitting a first Physical Uplink Shared Channel (PUSCH) in a first time unit of a set of time units;
determining whether the first time unit is a non-partitioned uplink-only time unit; and
transmitting the first PUSCH in the first time unit in accordance with the first frequency domain position when the first time unit is determined to be a non-partitioned uplink-only time unit.

9. The method of claim 8, wherein the first configuration includes a first frequency hopping offset, the method further comprising:
applying the first frequency hopping offset to derive the first frequency domain position.

10. The method of claim 8, wherein the first configuration includes a first frequency hopping offset, the method further comprising:
receiving an indication indicating enablement or disablement of frequency hopping within the RAR; and
disabling frequency hopping for transmitting the first PUSCH when the indication indicates disablement of frequency hopping.

11. The method of claim 8, further comprising:
receiving a second configuration for deriving a second frequency domain position in a partitioned time unit;
determining whether the first time unit is a partitioned time unit; and
transmitting the first PUSCH in the first time unit at the second frequency domain position when the first time unit is determined to be a partitioned time unit.

12. The method of claim 11, wherein the second configuration includes a second frequency hopping offset, the method further comprising:
applying the second frequency hopping offset to derive the second frequency domain position when the first time unit is determined to be a partitioned time unit.

13. The method of claim 12, wherein the second frequency hopping offset is narrower than a first frequency hopping offset to be applied to a non-partitioned uplink-only time unit.

14. The method of claim 8, further comprising:
receiving a bitmap indicating the set of time units.

15. The method of claim 14, wherein the bitmap is received within the RAR and each bit of the bitmap corresponds to a respective time unit.

16. The method of claim 14, wherein the bitmap indicates frequency hopping is disabled for partitioned time units and enabled for non-partitioned uplink-only time units.

17. The method of claim 8, wherein the scheduling grant schedules transmissions of a plurality of PUSCHs, including the first PUSCH, in the set of time units as repetitions, wherein a corresponding one of the plurality of PUSCHs is transmitted in a given time unit of the set of time units at the first frequency domain position when the given time unit is a non-partitioned uplink-only time unit.

18. The method of claim 17, further comprising:
receiving a second configuration for deriving a second frequency domain position in a partitioned time unit, wherein a corresponding one of the plurality of PUSCHs is transmitted in a given time unit of the set of time units at the second frequency domain position when the given time unit is a partitioned time unit and the second frequency domain position does not overlap with a downlink subband.

19. The method of claim 18, further comprising:
skipping a transmission of a corresponding one of the plurality of PUSCHs when the given time unit is a partitioned time unit and the second frequency domain position overlaps with a downlink subband.

20. The method of claim 19, further comprising:
receiving a configuration indicating for each time unit in the set of time units whether frequency hopping is enabled or disabled; and
applying frequency hopping for a corresponding one of the plurality of PUSCHs based on the configuration when the given time unit is a non-partitioned uplink-only time unit.

21. A method of wireless communication of a user equipment (UE), comprising:
receiving, from a base station, a Physical Uplink Control Channel (PUCCH) configuration for frequency hopping in response to a message 4 in a random access procedure;
determining a resource block number in a first slot for each frequency hop of the PUCCH transmission based on the PUCCH configuration, wherein the resource block number for a first hop and a second hop is determined using different equations contingent on a value of a PUCCH index; and
transmitting, in the first slot and when frequency hopping is not disabled, a Hybrid Automatic Repeat Request Acknowledgement (HARQ-ACK) on the PUCCH in response to the message 4, wherein the HARQ-ACK transmission applies frequency hopping according to the determined resource block number.

22. The method of claim 21, further comprising:
selectively disabling frequency hopping for the PUCCH transmission based on a type of the first slot, wherein the frequency hopping is disabled for partitioned slots with downlink subbands; and
